(19) United States
(12) Patent Application Publication
(10) Pub. No.: US 2026/0268203 A1
(43) Pub. Date: Sep. 10, 2026

(54) RESOLVING CELLULAR NETWORK CONNECTIVITY DEFICIENCIES USING MACHINE LEARNING-BASED TREND ANALYSIS

(71) Applicant: DISH Wireless L.L.C., Englewood, CO (US)

(72) Inventors: Shradha Niranjan Desai, Denver, CO (US); Ahmed Awwad Whdan, Centennial, CO (US)

(21) Appl. No.: 19/070,863

(22) Filed: Mar. 5, 2025

(51) Int. Cl. G06N 20/00

(52) U.S. Cl. CPC G06N 20/00

(57) ABSTRACT

A method includes executing accessibility algorithm(s) on connectivity data to determine a set of performance metrics for cellular network accessibility through network component(s). The method analyzes the performance metrics over time to detect trends and to determine correlations between network performance and access demand patterns. The method trains a ML model using, as inputs, the trends and the correlations detected within the performance metrics and monitors outputs of the ML to detect whether the outputs drop below performance threshold values for the network component(s). In response to detecting an output of the ML model drop below a performance threshold value for a network component, the method causes an increase in distributed unit or centralized unit resources associated with the network component that will increase a level of network accessibility to cellular devices through the network component.

### BACKGROUND

Telecommunication networks, such as cellular networks, have various resources that produce data and metadata concerning operations of the cellular network. Metadata is data that provides information about the data. Metadata enriches the data with information about one or more aspects of the data. Metadata insights can facilitate efficient processing and understanding of the data. Status reports, including error codes, may be generated based on data and metadata that are indicative of deficiencies in operations of the network, including deficiencies in network capacity and connectivity.

With the development of communication technologies, such as fifth generation (5G) new radio (NR) cellular networks, a massive number of connected devices are enabled via extensive cellular networks composed of a significant number of network components, which range from cells and sectors of individual cellular sites to distributed units (DUs) and centralized units (CUs) that interconnect cellular sites. These DUs and CUs provide a backbone of the cellular network and include hardware and software resources that facilitate an increasing demand of a growing number of cellular devices in cellular networks. In a growing number of network components, contractual levels of cellular device connectivity are not met.

### BRIEF DESCRIPTION OF DRAWINGS

The present disclosure is illustrated by way of example, and not by way of limitation, in the FIGURES of the accompanying drawings.

FIG. 1A is a block diagram of a cellular network system including a computing system in or associated with the cellular network for purposes of analyzing cellular device connectivity according to at least one embodiment.

FIG. 1B is a block diagram of the computing system of FIG. 1A according to some embodiments.

FIG. 2A, FIG. 2B, FIG. 2C, FIG. 2D illustrate a graphical user interface (GUI), including a map of an area of interest (AOI) of the cellular network, presentable on a display device of the computing system according to at least some embodiments.

FIG. 3 is an image of a menu presentable within the GUI as an overlay to the map and that provides selection options of various capacity-related aspects of the cellular network according to some embodiments.

FIG. 4 is a screen image of the GUI after selection, within an input selector window, of various components of the cellular network, including DUs and a CU, according to some embodiments.

FIG. 5 is an operational flow diagram of a method for employing connectivity data to train a machine learning model for the purposes of identifying connectivity deficiencies in network components based on vendor contracts according to some embodiments.

FIG. 6A is an example plot that can be displayed in the GUI and illustrates a percentage of voice connectivity through a CU according to one embodiment.

FIG. 6BA is an example plot that can be displayed in the GUI and illustrates a percentage of data connectivity through a CU according to one embodiment.

FIG. 7 is a flow chart of a method for determining connectivity deficiencies associated with one or more network components and example automated actions to resolve such connectivity deficiencies according to some embodiments.

FIG. 8 illustrates a block diagram illustrating an exemplary computer device (or computing device), in accordance with implementations of the present disclosure.

### DETAILED DESCRIPTION

As discussed above, as communication technologies advance, including the emergence of 5G new radio cellular networks, the number of connected devices grows, ensuring that cellular network connectivity and capacity bandwidth commensurately grows can be challenging. In some cellular networks, many network components, to include the DUs and CUs, are provided and maintained by third-party vendors that are contracted by a cellular network operator. By analyzing connectivity data associated with DUs and/or CUs, the cellular network operator has ascertained that some performance metrics related to connectivity (e.g., certain numbers of individual network devices can connect to or through a network component) are not being satisfied according to agreements with such third-party vendors.

Aspects and embodiments of the present disclosure overcome these deficiencies and others by leveraging sources of network data, to include connectivity data, to train a machine learning model that enables monitoring and tracking, over time, the level to which network components comply with (or satisfy) performance thresholds that component vendors are required contractually to supply and maintain. In some embodiments, this leveraging is facilitated by accessing (e.g., querying) and analyzing connectivity data through the help of big data analytics tools to such as Redshift of Amazon® Web Services (AWS®), Apache Spark, Tableau, Databricks, Cloudera, Talend, Qlik Sense, Amazon® Athena, Apache Kafka, KNIME, SAS, Apache Cassandra, Apache Hadoop, MongoDB, and/or Teradata Vantage, some of which are proprietary (like Redshift) and others of which (like Apache Spark and Apache Hadoop) are open source. For example, Redshift is a fully managed, petabyte-scale data warehouse service designed to enable fast and efficient analysis of large-scale datasets. Redshift is widely used for big data analytics, reporting, and business intelligence while Tableau excels in data visualization and interactive dashboards. Such tools enable efficient access and analysis of connectivity and capacity data that is made available through cellular network data and metadata that is gathered from network components during cellular network operation.

In some embodiments, for example, a cloud-based computing system (which can be distributed) executes one or more accessibility algorithms on the cellular connectivity data to determine a set of performance metrics for cellular network accessibility through one or more network components of the cellular network. The computing system can further pre-process, to generate enhanced performance metrics, the performance metrics based on temporal shifts detected in the performance metrics, e.g., due to data being generated at different times by different network components. In various embodiments, the performance metrics can include a percentage of radio resource control (RRC) connection attempts that are successful, a percentage of data resource block (DRB) setup attempts that are successful, or a percentage of voice-over-new radio (VoNR) connection attempts that are successful.

In such embodiments, the computing system further analyzes the performance metrics over time to detect trends in the performance metrics and to determine correlations between network performance and network access demand patterns (or network load patterns). The computing system can further training a machine learning model using, as inputs, the trends and the correlations detected within the performance metrics. This training can be updated at regular intervals upon retrieving updated connectivity data. In some embodiments, the computing system monitors outputs of the machine learning model to detect whether the outputs drop below performance threshold values for the one or more network components. For example, vendor contracts associated with network components can be analyzed to determine the number of successful RRC, DRB, or VoNR connection attempts that should be supported by any given network component.

In response to detecting an output of the machine learning model drop below a performance threshold value for a first network component, the computing system can trigger or cause an increase in one of DU or CU resources associated with the network component that will increase a level of network accessibility to cellular devices through the network component. Alternatively, or in addition, the computing system can trigger generation and transmission of a service ticket to a vendor computer associated with the first network component so that the vendor can initiate a corrective action related to the network component.

To facilitate visualization and tracking of capacity and connectivity levels of network component, in some embodiments, the computing system executes a compute-driven capacity planning tool that presents, within a display device, based on geolocation data, a graphical user interface (GUI) having a map with graphical objects representing components (or elements) of cellular sites of a cellular network throughout a selectable area of interest (AOI). The computing system can also determine, using call record detail (CDR) data, a capacity metric volume and connectivity data for each cell of a plurality of sites covering the AOI. In differing embodiments, the capacity metric volume and/or the connectivity data corresponds to capacity-based and connectivity-based performance metrics such as RRC connections (e.g., number of subscriber devices to connect to a particular network component), percentages of successful RRC, DRB, or VoNR connection attempts, traffic volume, or unserved demand bandwidth (e.g., amount of streaming data that was deficient to fulfill streaming demands), among others.

Particular implementations of the subject matter described in this disclosure can be implemented so as to realize one or more of the following advantages. For example, the disclosed machine learning-based approach to monitoring and tracking connectivity levels associated with different performance metrics enables streamlining detecting connectivity deficiencies associated with specific, individual network components. For example, by also tracking and comparing connectivity levels (generated as machine learning outputs) with contractual performance threshold values, a trained machine learning model can facilitate quick and accurate detection of such connectivity deficiencies. In a larger computing flow, which includes the machine learning training, such detected connectivity deficiencies can trigger real-world action to resolve or otherwise address the connectivity deficiencies. In embodiments, these triggered actions can include automating generation of an alert (such as a service ticket) to a vendor of that specific network component having the deficiency and/or increase DU and/or CU resources associated with the network component. Additional advantages, as would be apparent to those skilled in the art of cellular network planning and maintenance, will be discussed hereinafter.

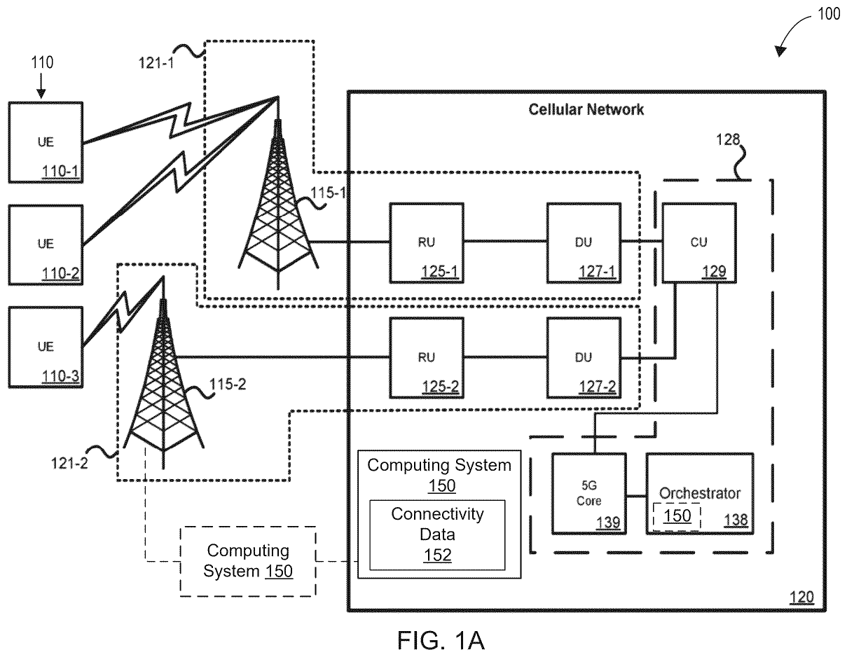

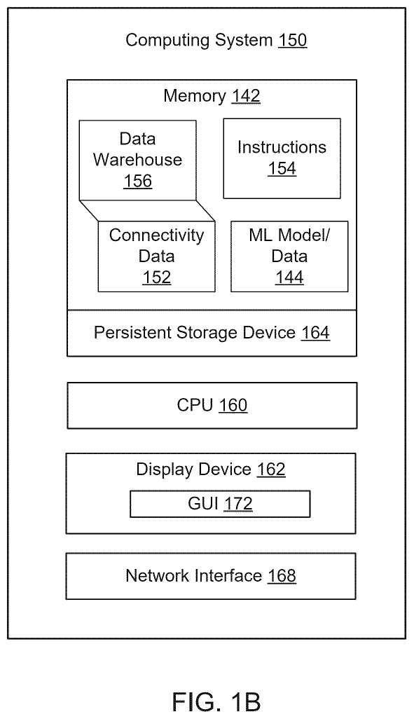

FIG. 1A is a block diagram of a cellular network system 100 including a computing system 150 in or associated with the cellular network for purposes of analyzing cellular device connectivity according to at least one embodiment. FIG. 1A represents an embodiment of a cellular network which can accommodate the cloud-based architecture. System 100 can include a 5G New Radio (NR) cellular network; other types of cellular networks, such as 6G, 7G, etc. may also be possible. System 100 can include: user equipment (UEs) 110 (e.g., UE 110-1, UE 110-2, UE 110-3); base station structure 115; cellular network 120; radio units 125 (“RUs 125”); distributed units 127 (“DUs 127”); centralized unit 129 (“CU 129”); 5G core 139, and orchestrator 138. FIG. 1A represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware can be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), and other computerized devices capable of communicating via a cellular network, etc. Generally, UE 110 can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs and 5G core 139. Each structure 115 can include one or more antennas that allow RUs 125 to communicate wirelessly with UEs 110. RUs 125 can each represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1 and DU 127-2, may communicate with CU 129. Collectively, an RU, DU, and CU create a gNodeB, which serves as the radio access network (RAN) of cellular network 120. CU 129 can communicate with the 5G core 139. The specific architecture of the cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1A illustrates various components of cellular network 120, other embodiments of cellular network 120 can vary the arrangement, communication paths, and specific components of cellular network 120, which will be expanded on in subsequent Figures. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. In embodiments, the orchestrator 138 represents various software processes executed by underlying computer hardware. Orchestrator 138 can monitor the cellular network 120 and determine the amount and location at which cellular network functions should be deployed to meet or attempt to meet service level agreements (SLAs) across slices of the cellular network.

In embodiments, the orchestrator 138 allows the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so it may be desired to avoid allocation of an excess of resources to a particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing can be performed.

The 5G core 139, which can be physically distributed across data centers or located at a central national data center (NDC), can perform various core functions of the cellular network. The 5G core 139 can include: network resource management components; policy management components; subscriber management components; and packet control components. Individual components may communicate on a bus, thus allowing various components of 5G core 139 to communicate with each other directly. The 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The 5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

As illustrated in FIG. 1A, the system 100 includes a computing system 150 or data platform. The computing system 150 can be distrusted in some embodiments and include a suite of tools and technologies designed to manage, store, process, analyze, and/or visualize large volumes of data. In varying embodiments, the computing system 150 is located in or implemented as part of the orchestrator 138, is located within the cellular network 120 but outside of the main cellular network components 128, or is located outside of the cellular network 120 but is capable of monitoring data such as capacity information by connecting to the cellular network 120 in similar ways that does a UE.

In at least one embodiment, the computing system 150 is a distributed set of processing devices located in one or more of these three locations that can share one or more memory or storage devices that are capable of storing connectivity data 152 (see FIG. 1B), which can also include capacity data. In embodiments, the connectivity data 152 is associated with user devices (e.g., the UEs 110) and their success rates of connecting to (or being setup for communication with) particular network components such as CUs or DUs. Such success rates can be in relation to RRC connection attempts, DRB setup attempts, or VoNR connection attempts. These and other metrics (such as capacity metrics) are obtainable by determining bandwidth of various network components (taken alone and in the aggregate in some cases), call record detail (CDR) data, throughput, network traffic and associated demands for the bandwidth. The computing system 150 can aggregate and track such connectivity data 152 for purposes of determining and updating connectivity metrics at various layers of the cellular network 120 that informs whether particular network components are experiencing certain connectivity deficiencies. In some embodiments, these connectivity deficiencies derive from deficiencies in capacity that are expected to result in breaks (e.g., dropped calls or dropped network sessions) and the like that result in negative QoS and QoE.

In some embodiments, the computing system 150 is used by modern data-driven organizations, enabling them to harness the power of their data for various purposes, such as business intelligence, analytics, machine learning, and more. In general, the computing system 150 includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The computing system 150 can include data storage components, such as data lakes, data warehouses, database systems. Data lakes are large storage repositories that hold raw data in its native format until it is needed. Data warehouses is structured storage systems optimized for query performance and analytics, often storing cleaned and processed data. Database Systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring.

Data management components can handle metadata management and data governance. The metadata management can include tools for managing metadata, which is data about data, including data catalogs, lineage, and governance. Data Governance can include policies and processes to ensure data quality, security, privacy, and compliance with regulations. Data integration components can provide application programming interfaces (APIs), data virtualization, etc. The APIs can be used for accessing and integrating data across different systems. Data Virtualization techniques can be used for abstracting and integrating data from various sources without moving it physically. The data analytics components can have Business Intelligence (BI) and advanced analytics tools and platforms for data reporting, visualization, and dashboards to support decision-making. Advanced analytics techniques, like data mining, predictive analytics, and statistical analysis, can be used to derive deeper insights. The ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches.

The computing system 150 can consolidate data from various sources into a single platform, making it easier to manage and access. The computing system 150 can support large-scale data storage and processing, accommodating growing data volumes and increasing complexity. The computing system 150 can enable real-time data processing and analytics, allowing organizations to respond quickly to changing conditions. The computing system 150 can facilitate collaboration across different departments and teams by providing a unified data environment. The computing system 150 can implement data governance and quality control measures to ensure the accuracy and reliability of data. The computing system 150 can provide organizations with the tools and insights needed to make informed, data-driven decisions. In summary, the computing system 150 can provide the infrastructure and tools needed to manage, process, and analyze data effectively, enabling organizations to unlock the full potential of their data assets. The computing system 150 can also provide business intelligence and reporting. The computing system 150 can aggregate data from multiple sources to generate comprehensive reports and dashboards for business analysis. The computing system 150 can provide real-time analytics. In particular, the computing system 150 can monitor and analyze data streams in real-time to gain immediate insights and drive instant actions. The computing system 150 can provide customer insights by analyzing customer data to understand behavior patterns, preferences, and trends to improve customer experience and loyalty. The computing system 150 can implement predictive maintenance as well, such as using machine learning models to predict equipment failures, capacity deficiencies, and schedule proactive capacity solutions and/or maintenance.

FIG. 1B is a block diagram of the computing system 150 of FIG. 1A according to some embodiments. In at least some embodiments, the computing system 150 includes memory 142, a central processing unit (CPU) or other processor, a display device 162, a persistent storage device 164, and a network interface 168. The memory 142 (as well as the persistent storage device 164) can store a ML model 144 (and data or parameters), a data warehouse 156, connectivity data 152 (which optionally is structured within the data warehouse 156), and instructions 154. The CPU 160 can include one or more processing devices in the case that the computing system 150 is distributed (such as is common in cloud computing), while the memory 142 and the persistent storage devices 164 (among other components) may or may not be distributed, e.g., located across different locations of a network such as the cellular network 120 or within the cloud with which the cellular network 120 communicates.

For example, in embodiments, the computing system 150 is implemented in a cloud computing system, providing data storage, data warehousing, real-time data processing, analytic engines for large-scale data processing, ML/AI services, data flow for stream and batch processing, or other data services. As described in more detail below, the computing system 150 can provide and present a GUI 172 within the display device 162 in connection with a capacity planning tool and ML-based computing tools. These tools may be instantiated within the instructions 154, which when executed by the one or more processing devices of the CPU 160, performs the disclosed processes and/or presents the GUI 172 with a map and various menus and views associated with the map that will be discussed in more detail hereinafter. In some embodiments, the GUI 172 includes, in connection with the CPU 160, a framework capable of generating and/or modifying executable code (represented by graphical objects in the GUI) for utility programs, applications, functions, routines, scripts, processing pipelines, solutions, connector functions, object stores, enterprise integration tools, or other executable code associated with capacity planning.

As discussed, the connectivity data 152 can be associated with connection success rates by cellular devices (e.g., the UEs 110) to or through various network components. The computing system 150 can aggregate and employ such connectivity data 152 (or analyzed performance metrics generated from the connectivity data 152) for purposes of training the ML model 144 in a particular way as will be discussed in more detail. The computing system 150 can also aggregate capacity-related data at various layers of the cellular network 120 that informs whether particular network components have (or will have at some point in the future) capacity-related issues that are expected to result in breaks (e.g., dropped calls or dropped network sessions) and the like that result in negative QoS and QoE. In some embodiments, the capacity-related or connectivity-related performance metrics are stored in the persistent storage device 164 and, as needed, in the memory 142 when being updated with newly received network data. In this way, connectivity metrics associated with various network components can be updated over time in order to update training the ML model 144. Further, capacity metrics can be updated over time and presented, through various means (such as text box, overlay graphics, and the like) to the GUI 172.

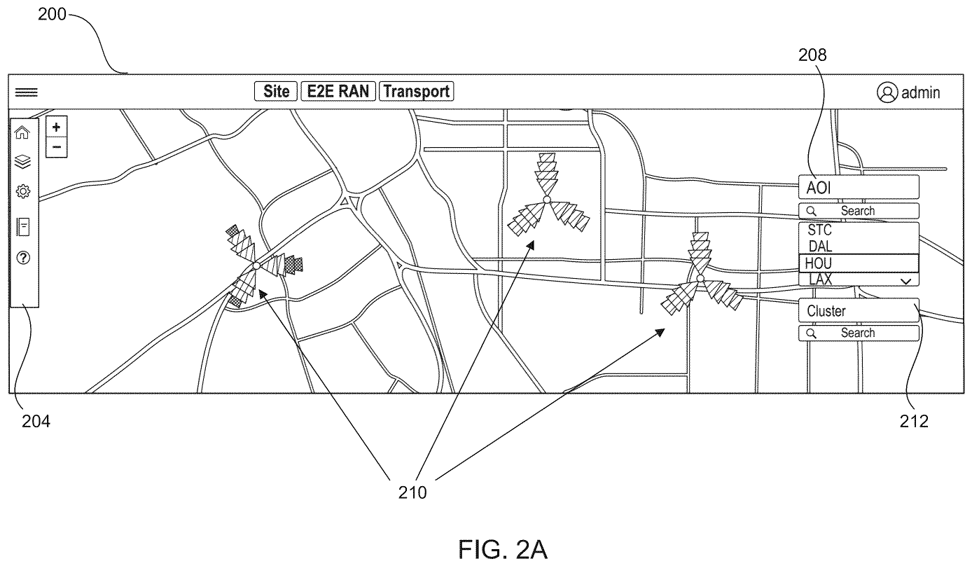

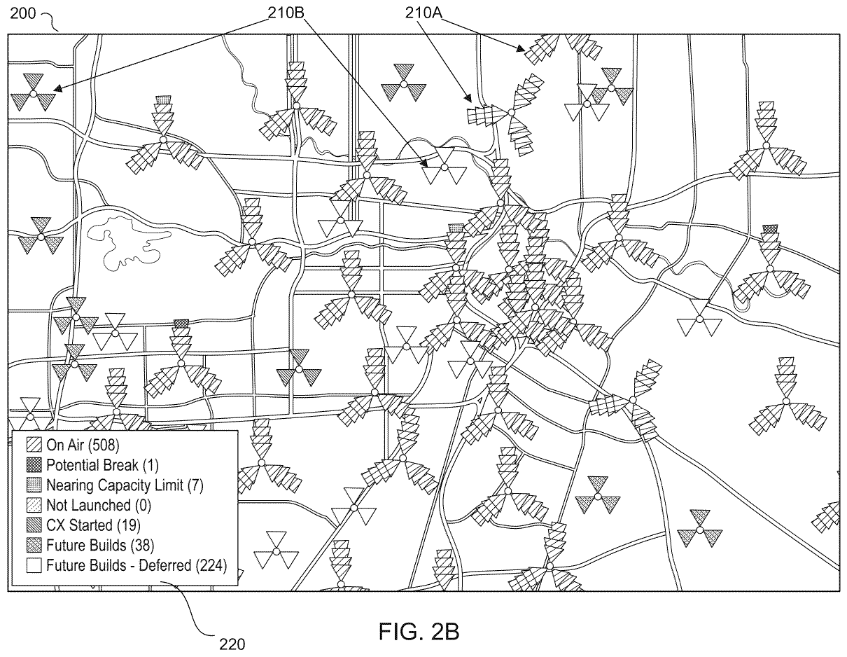

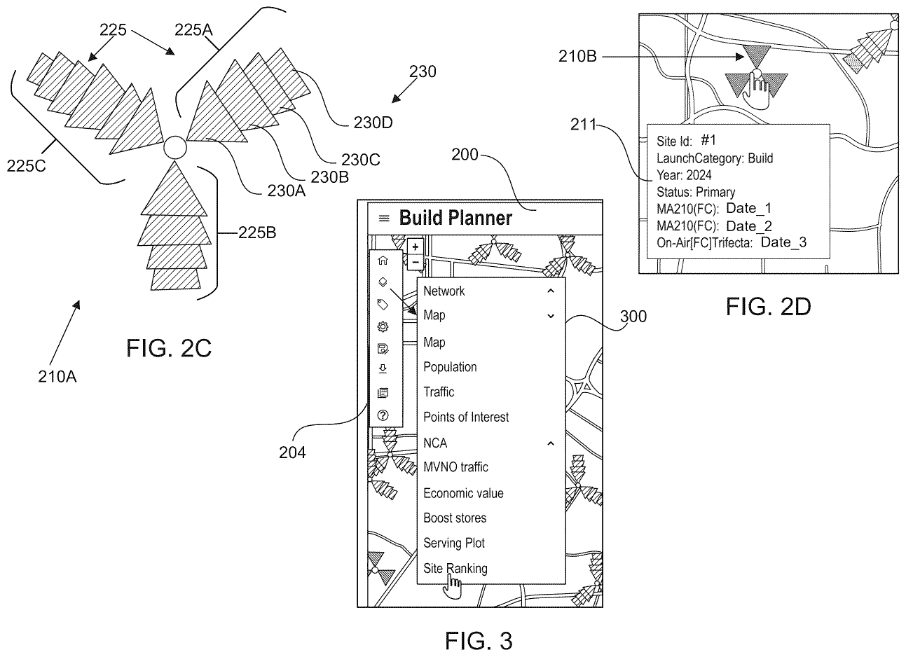

FIG. 2A, FIG. 2B, FIG. 2C, FIG. 2D illustrate a graphical user interface or GUI 200, including a map of an area of interest (AOI) of the cellular network 120, presentable on the display device 162 of the computing system 150 according to at least some embodiments. In some embodiments, the GUI 200 is the GUI 172 discussed with reference to FIG. 1B. The computing system 150 can present, in the GUI 200, a main menu 204, an AOI selector 208, and a cluster selector 212 (FIG. 2A) along with components of the cellular network 120, e.g., which can include a plurality of sites 210 of the cellular network 120.

In embodiments, the main menu 204 enables selecting various functionalities or features of the capacity planning tool executed by the computing system 150, e.g., see FIG. 3. These functionalities and features will be discussed in detail as relevant to the present disclosure. For example, a user can select an export icon on the main menu 204 that enables exporting tabular data having selectable views and filters. The tabular data, for example can list component identifier (ID) and corresponding capacity metrics.

The AOI selector 208 may be a drop-down menu of selectable AOIs, which are pulled from a database or data store (e.g., of the persistent storage device 164), and which may be searchable within a separate text input box. As illustrated, the current user has selected Houston (HOU) as the AOI. In embodiments, the cluster selector 212 functions similar to the AOI selector 208, except that a cluster is a subset of the selected AOI and can therefore provide better granularity, e.g., by zooming into a dense cluster of sites within an urban environment for example.

The term “selection” will be referenced throughout this description making reference to use of a cursor or mouse pointer (or the like input/output (I/O) device) of the computing system 150 to select a link, icon, indicator, or other selectable option within the GUI 200. This selection can be performed differently in different embodiments, such as hoovering over or clicking on the option, whether a right click, a middle click, or a left click, as may be available. Different forms of selection may enable access to different types or groups of data or information, to include keyboard or touch screen selection options. Those skilled in the art will recognize other ways that options within a GUI 200 are selected by a user or operator through various I/O devices.

In at least some embodiments, in response to detecting selection of an AOI through the AOI selector, the computing system 150 retrieves (e.g., from the persistent storage device 164) geolocation data for the plurality of sites 210 of the cellular network 120 within the AOI. The computing system 150 can further present, within the GUI 200 over the map, graphical objects representing the plurality of sites 210, e.g., the components of those sites as will be discussed in detail. The graphical objects can include indicators for a plurality of cells of the plurality of sites, as discussed below with reference to FIG. 2B. A user can then zoom in and out to inspect, hover over, or click on the indicators associated with the plurality of sites to perform different functions that will be discussed.

As illustrated in FIG. 2B, the sites 210 can be classified as active sites 210A (e.g., on-air sites) or non-active sites 210B. In various embodiments, a legend 220 can identify what kinds of sites these are by particular shading and how many of each kind exist in the AOI, e.g., via a number in parentheses after the site type in the legend 220. For example, the non-active sites 210B can include sites that are not launched, in-construction, future-builds, or future-builds deferred. The not-launched sites may be construction but not yet active, the in-construction sites not yet fully built, the future-build sites may be allocated for construction, and the deferred sites have been identified but not prioritized (or ranked sufficiently) high to be allocated to be built.

FIG. 2C illustrates a plurality of indicators for any active site 210A presented in the GUI 200 following selection of a particulate AOI. In this example, the active site 210A can include three sectors 225, e.g., a first sector 225A, a second sector 225B, and a third sector 225C. Each sector can be orientated at approximately 120 degrees apart, or other equidistant value to minimize cross-cell interference between sectors, pointing in different directions, referred to as azimuths. Each sector can include multiple cell indicators 230, typically between two and six cell indicators per sector corresponding to the actual cells, which are configurable depending on traffic demand among other factors. As illustrated, the first sector 225A includes a first cell indicator 230A of a first cell, a second cell indicator 230B for a second cell, a third cell indicator 230C for a third cell, and a fourth cell indicator 230D for a fourth cell. Further, a frequency band deployed by each cell in a sector can be a different frequency band to increase overall capacity of the sector. In some embodiments, a separate cell indicator can be used for a different band if a cell is able to multiplex between bands, for example. In this way, the capacity data can be organized according to sector and cell of each site, the cells within each sector include between two and six different frequency bands.

FIG. 2D illustrates a non-active site 210B, which when selected (e.g., hoovered over or clicked) causes the computing system 150 to present, in the GUI 200, particular site information in a text box 211. This particular non-active site 210B is in construction and is illustrated only by way of example, as each site illustrated on the map, when selected, can present the same or different site information. In this example, the site information in the text box 211 includes a site identifier (ID), a launch category (e.g., build), a year 2024, a status, and other date information, including a projected on-air date.

With additional reference to FIG. 2B, the indicators of each site can be shaded to indicate a capacity status that can be derived from one or more capacity metrics for each respective site, where the indicators relate to cells and/or sectors of each site. For example, as illustrated in the legend 220, the status can include on-air (e.g., is active and functioning with normal capacity), involves a potential break, or is nearing a capacity limit. In embodiments, a potential break can be restated as at least one capacity metric of a plurality of capacity metrics for the cell (or sector) satisfies a predetermined capacity threshold, where satisfying the capacity threshold means meeting or exceeding a value for the capacity threshold. Each capacity metric can be associated with a corresponding predetermined capacity threshold to make this determination. Further, nearing a capacity limit can be restated as at least one capacity metric of the plurality of capacity metrics is within a particular percentage of the predetermined capacity threshold. In this way, satisfying the particular percentage means the capacity metric is nearing the capacity limit, which can be shaded differently.

FIG. 3 is an image of a menu 300 presentable within the GUI 200 as an overlay to the map and that provides selection options of various capacity-related aspects of the cellular network according to some embodiments. For example, a multi-layer icon can be selected from the main menu 204, which causes the menu 300 to pop up over the map listing high-level menu options, such as “Network” (see FIG. 10B) and “Map.” In embodiments, selection of “Map” can cause a drop down of further options, such as map, population, traffic, points of interest, economic value, cellular stores, serving plot, and site ranking, not all of which will be discussed herein. When one of the “Map” options is selected, corresponding graphical indicators and information can be illustrated on the map so that such indicators and information is selectively displayed, to maintain simplicity of what is shown on the map. For example, if too many indicators or too much information is simultaneously displayed, the map would be too congested to meaningfully discern and use the displayed content.

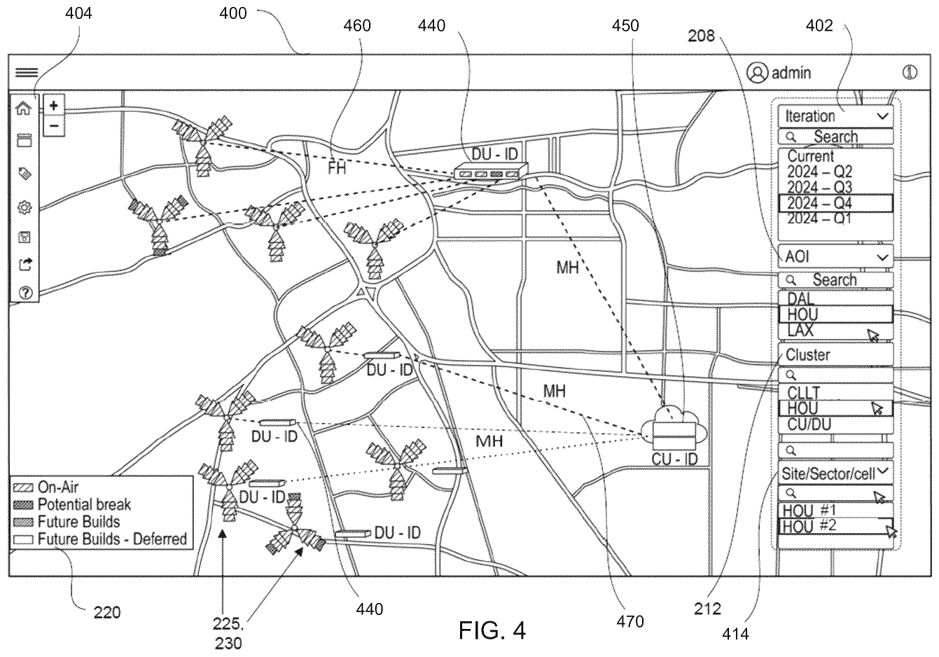

FIG. 4 is a screen image of a GUI 400 after selection, within an input selector window, of various components of the cellular network 120 according to some embodiments. In some embodiments, the GUI 400 is the same as the GUI 200 of FIGS. 2A-2D and some components are similarly or identically labeled as in FIG. 2A-2D. Not illustrated is an image of an exemplary input selector window within the GUI 400 from which to select the various components according to some embodiments. For example, the input selector window can include check boxes for various cellular components of the cellular network 120, to include cells 230, sectors 225 (see FIG. 2C), centralized units (or CUs 450), distributed units (or DUs 440), cell site routers (CSRs), front-haul segments 460 (or FHs), and mid-haul segments 470 (or MHs). In embodiments, each DU 440 is assigned an ID and each CU 450 is assigned an ID by which network traffic can be tracked and directed by the CSRs. In at least some embodiments, the connectivity and capacity data associated with these network components can be stored within the memory 142 (FIG. 1B), such as in the data warehouse 156, and used to determined capacity and connectivity performance metrics.

In some embodiments, in response to detecting, through the input selector window, selection of one or more component types of the plurality of component types, the computing system 150 retrieves geolocation data for a plurality of components corresponding to the selected one or more component types. The computing system 150 can then present, within the GUI 400 over the map, graphical objects representing the plurality of components consistent with the geolocation data. The computing system 150 can then retrieve capacity and connectivity data associated with the plurality of components. The computing system 150 can then shade, based on the capacity data, each graphical object to indicate a capacity status associated with each corresponding component of the plurality of components.

For example, as illustrated in the legend 220, the status can include on-air (or being active and functioning with normal capacity), involves a potential break, or is nearing a capacity limit. In embodiments, a potential break can be restated as at least one capacity metric of multiple capacity metrics for the cell (or sector) satisfies a predetermined capacity threshold, where satisfying the capacity threshold means meeting or exceeding a value for the capacity threshold. Each capacity metric can be associated with a corresponding predetermined capacity threshold to make this determination. Further, nearing a capacity limit can be restated as at least one capacity metric of the plurality of capacity metrics is within a particular percentage of the predetermined capacity threshold. In this way, satisfying the particular percentage means the capacity metric is nearing the capacity limit, which can be shaded differently.

In some embodiments, when the one or more component types are selected from the input selection window 405, presenting the graphical objects within the GUI 400 includes presenting a subset of cells for each site, a plurality of DUs 440, at least one CU 450, a plurality of front-haul segments connecting each site to a respective DU 440, and a plurality of mid-haul segments connecting each DU 440 to the at least one CU 450.

In one or more menu sections the GUI 400 can also include the AOI selector 208, the cluster selector 212, a date selector 402 to select a date at which capacity of connectivity data is to be predicted, and a component selector 414 adapted for selection of a site, sector, or cell of the site. In some embodiments, the computing system 150 presents the AOI selector 208 in the GUI 400. In response to detecting selection of an AOI, through the AOI selector 208, the computing system 150 can retrieve the geolocation data and the capacity data from a database portion that is specific to the AOI, e.g., from the memory 142 and/or persistent storage device 164. The computing system 150 can then present, within the GUI 400 over the map, graphical objects representing the plurality of components consistent with the geolocation data, as illustrated in FIG. 4.

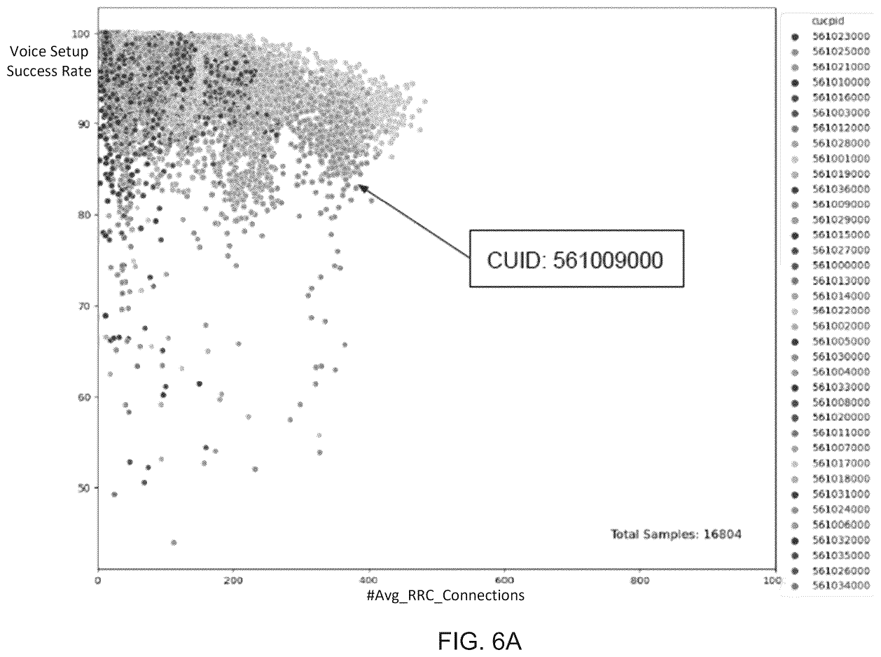

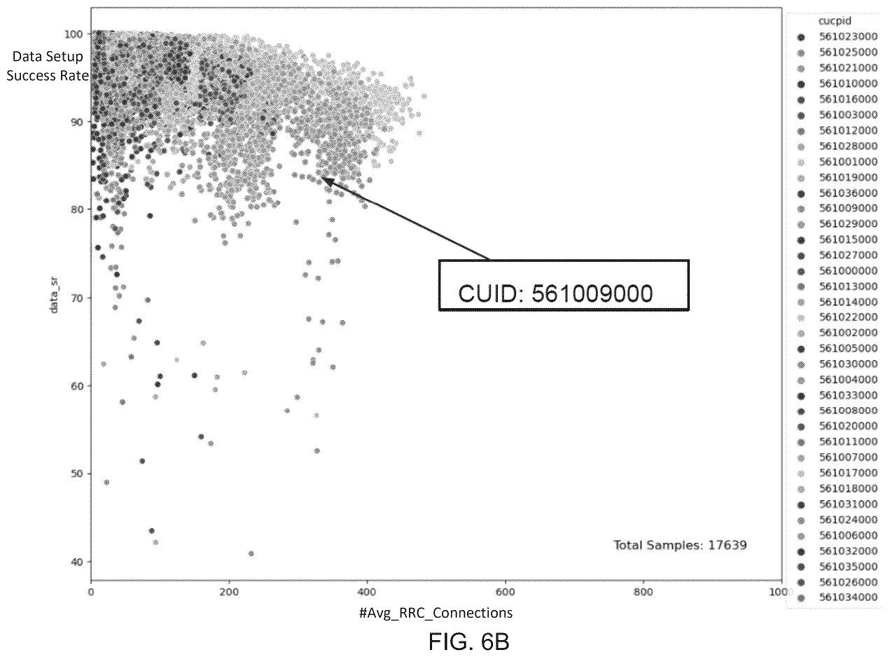

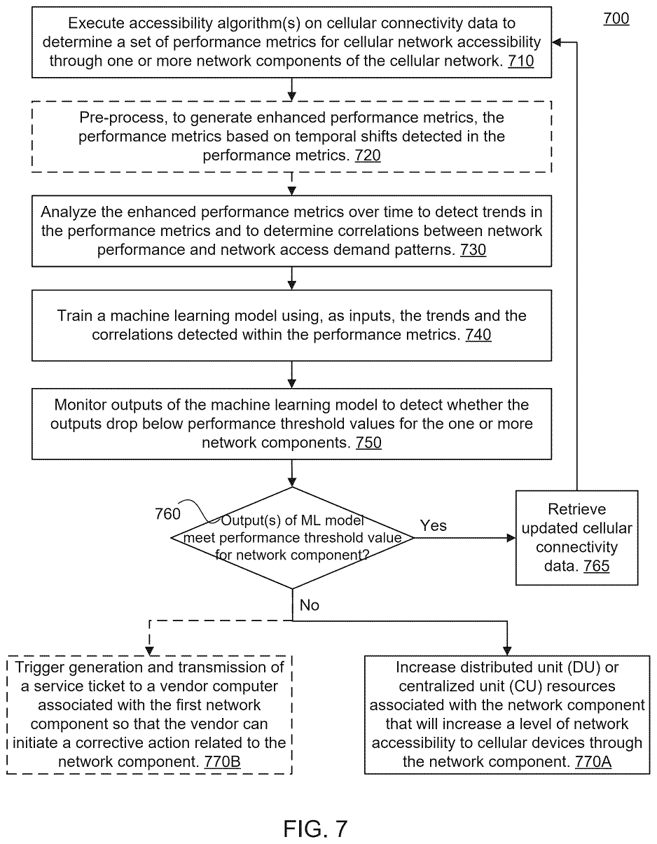

In some embodiments, in response to detecting selection of a graphical object of the graphical objects, the computing system 150 determines, using the capacity data, a plurality of capacity metrics associated with the graphical object. The computing system 150 can further present, within the GUI 400 as an overlay of the map, a text box including values for the plurality of capacity metrics. Providing such capacity metric values was discussed by way of example with reference to FIG. 6 for cells 230 and FIG. 7 for sectors.

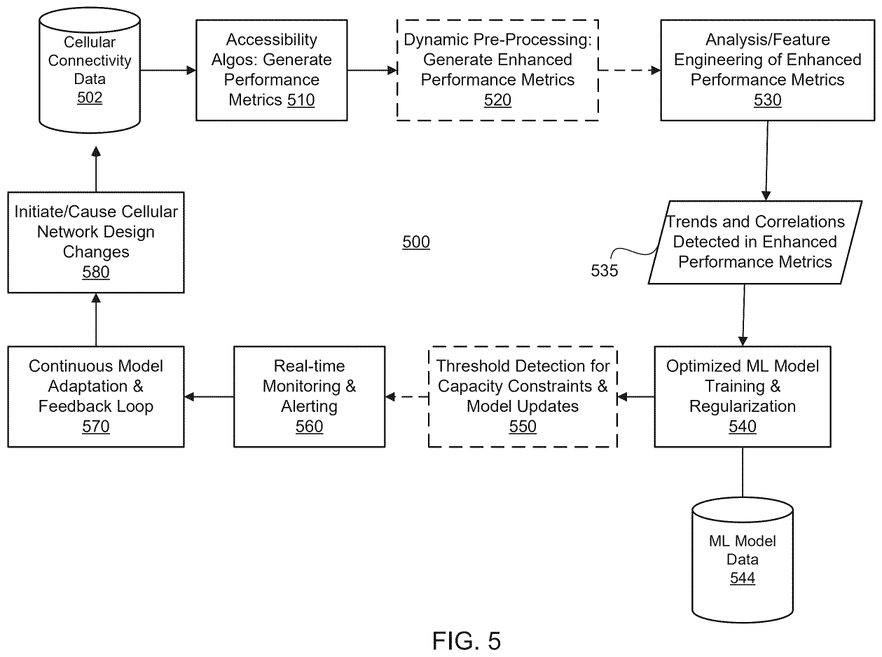

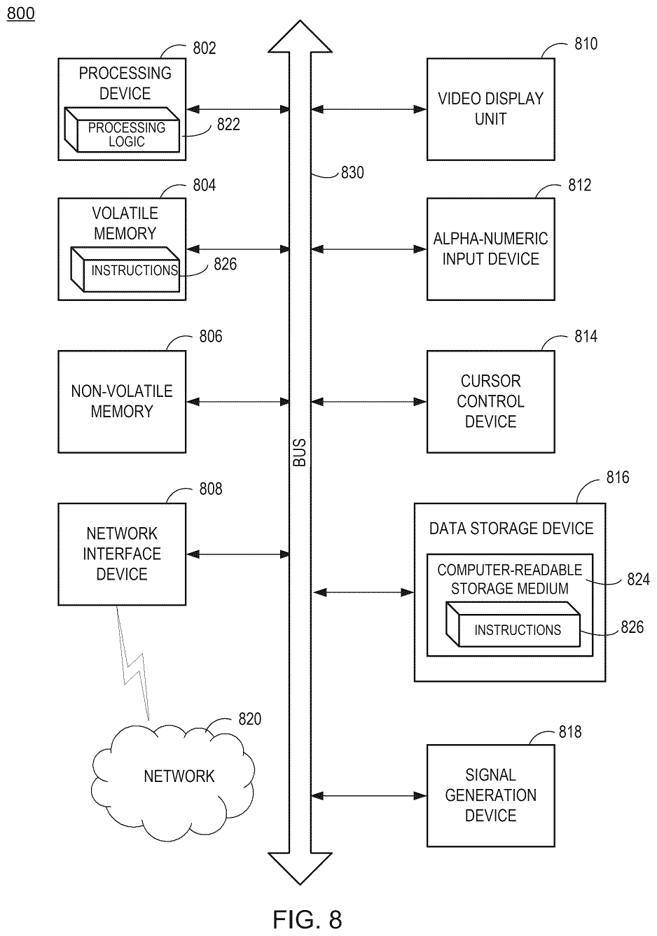

FIG. 5 is an operational flow diagram of a method 500 for employing connectivity data to train a machine learning model for the purposes of identifying connectivity deficiencies in network components based on vendor contracts according to some embodiments. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 500 is performed by the computing system 150 of FIGS. 1A-1B to include employing one or more processing devices if the computing system 150 is implemented in a distributed cloud architecture as was discussed previously. The method 500 can also be performed by other computing systems described herein, such as in FIG. 8.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic inputs cellular connectivity data 502 into one or more accessibility algorithms to determine a set of performance metrics. The cellular connectivity data 502 can be the connectivity data 152 of FIGS. 1A-1B. In some embodiments, this processing involves automated data ingestion and synchronization. For example, the processing logic can query Redshift to obtain updates at regular intervals to the connectivity data 502 that is used to generate the performance metrics data. In embodiments, such performance metrics data includes a plurality of RRC connection attempts that are successful, a percentage of a plurality of DRB setup attempts that are successful, or a percentage of VoNR connection attempts that are successful.

$$100 * m ( RRC\_ConnEstabSucc \_Sum ) / m ( RRC\_ConnEstabAtt \_Sum ) * ( m ( DRB\_EstabSucc \_FIVEQI1 ) / m ( DRB\_Estab \_Att \_FIVEQI1 ) ) \qquad ( 1 )$$

In one embodiment, for example, Equation (1) is employed as an accessibility algorithm that is based both on RRC successful connection attempt rate as well as DRB successful establishment rate. RRC is a protocol used in mobile networks, including 5G, to manage the connection between user devices and the network. For example, RRC handles the setup, maintenance, and release of the connection, as well as the allocation of radio resources to ensure efficient communication. In 5G, a data resource block (DRB) or physical resource block is the smallest unit of resources that can be allocated to a user device for data transmission. DRBs can be composed of multiple subcarriers and time slots, and be used to allocate bandwidth to users, optimizing the use of the available spectrum.

Voice over new radio refers to the capability of a 5G network to support voice calls over the 5G New Radio (NR) technology, which is the radio access technology used in 5G. For example, VoNR is the 5G equivalent of VoLTE (Voice over LTE) in 4G networks and enables voice calls to be transmitted over the 5G network rather than falling back to 4G or older networks. This allows for higher quality voice services, lower latency, and better integration with other 5G services.

In some embodiments, also in conjunction with operation 510, the processing logic dynamically adds timestamp and geographic information to the cellular connectivity data 152 to enable temporal and spatial analytics. The a customized ingestion pipeline associated with the processing logic or computing system can also adapt in relation to data traffic fluctuations, ensuring synchronization with real-time network conditions and optimizing the processing of cellular connectivity data. In some embodiments, the processing logic causes this adaptation of data refresh rates, by the customized ingestion pipeline, to network load patterns, ensuring synchronization and optimized processing of the cellular connectivity data 152.

At operation 520, the processing logic dynamically pre-processes the performance metrics to generate enhanced performance metrics based on temporal shifts detected in the performance metrics. While this data pre-processing can be helpful in terms of improving accuracy of the method 500, it is optional inasmuch as the method 500 can still be successfully carried out without operation 520.

In varying embodiments, the pre-processing at operation 520 includes extrapolating missing values of the performance metrics using context-sensitive methods including data associated with a nearest neighbor network component. The pre-processing can further include normalizing numerical fields within the performance metrics to standardize scale and improve prediction accuracy of network performance trends, capacity constraints, and service quality metrics, enabling proactive optimization of resource allocation. The pre-processing can further filter out outliers using interquartile range (IQR) or Z-score methods selectively based on feature sensitivity that includes seasonal trends. This hybrid approach can ensure that pre-processed data (e.g., the enhanced performance metrics) accurately reflects real-world network conditions.

At operation 530, the processing logic analyzes the enhanced performance metrics over time to detect trends in the enhanced performance metrics and to determine correlations between network performance and network access demand patterns (or network load patterns). This analysis can be understood as exploratory data analysis (EDA) this is particularly focused on identifying trends in the connectivity data 502. In some embodiments, the analysis at operation 530 can be or include adaptive feature engineering.

In varying embodiments, the processing logic, at operation 530, calculates and plots the enhanced performance metrics using queries provided to the data warehouse 156 storing the cellular connectivity data 152. The processing logic can further display the trends in the performance metrics within the GUI 172 using a visualization tool such as Matplotlib or Tableau. FIG. 6A is an example plot that can be displayed in the GUI 172 and illustrates a percentage of voice connectivity through a CU according to one embodiment. FIG. 6BA is an example plot that can be displayed in the GUI 172 and illustrates a percentage of data connectivity through a CU according to one embodiment. The processing logic can further make, based on historical data accessible via the data warehouse 156, real-time adjustments to the performance threshold values, enabling dynamic detection of performance degradation.

In at least some embodiments, the analysis performed at operation 530 includes different feature engineering such as deriving, directly from the enhanced performance metrics, load metrics, accessibility trends, and geographic density associated with the cellular network accessibility through the one or more network components. The processing logic can further combine the distributed unit loads and/or centralized unit loads with population density to determine the correlations between network performance and network access demand patterns. The analysis and feature engineering of operation 530 can leverage domain-specific insights to extract meaningful relationships from the data. For the CU level, comparisons can be made between user devices compared to accessibility or performance metrics. Here, domain-specific can refers to the level of 5G network (like DUs/CUs) where the user data is being analyzed.

At operation 535, the processing logic provides or inputs the trends and correlation detected within the enhanced performance metrics to a machine learning (ML) model, e.g., as inputs to the ML model discussed with reference to operation 540.

At operation 540, the processing logic continuously trains the machine learning model using, as inputs, the trends and the correlations detected within the performance metrics and generates outputs indicative of performance threshold values. These performance threshold values can be comparable to performance expectations by cellular component vendors, as will be discussed in more detail hereinafter.

For example, a suite of regression models, including Ridge, Lasso, and Elastic Net, can be trained using pre-processed or the enhanced performance metrics data. Elastic Net is a regularization technique in machine learning and statistics, combining L1 regularization (Lasso) and L2 regularization (Ridge) to improve predictive accuracy and interpretability of regression models. Elastic Net is especially useful when dealing with datasets that have many features, some of which may be highly correlated or irrelevant. Advantages of using Elastic Net include robust against multicollinearity (like Ridge) and performs feature selection (like Lasso), reduces the risk of overfitting by regularizing model complexity, and adjustable parameters (α and λ) allow customization for specific datasets.

In some embodiments, also associated with operation 540, the processing logic inputs model predictions within the outputs of the machine learning model to a file of a structured data format that is acceptable by the data warehouse 156. For example, such files can be stored, at least temporarily, in a ML model database 544, which can also be stored in the memory 142 (FIG. 1B). The processing logic can further execute a plurality of software libraries to implement extract, transform, and load (ETL) on the file to upload the model predictions to a target table in the data warehouse 156. In one embodiment, the target table is the ML model database 544.

In at least some embodiments, the ML training performed at operation 540 includes training one or more regression models using the performance metrics (or the enhanced performance metrics data) and employing custom-defined mean squared error (MSE) and R-squared thresholds to fine-tune hyperparameters and balance bias and variance within the performance metrics. The hyperparameters, bias, and variance values are known parameters used for training machine learning models such as Elastic Net and improving output predictions.

Also at operation 540, the processing logic can perform a time-series cross-validation between historical trends and current trends to ensure the machine learning model reflects the historical and current trends in the network performance. The processing logic can further calibrate a mean absolute error (MAE) and the R² (or R-squared) thresholds against historical degradation patterns and automatically adjust the performance threshold values based on the current network trends. In this way, the trained ML model can detect whether accessibility has dropped below certain levels (which can be historical) by a certain percentage, and this determination can be made relevant to specific components provided by certain vendors.

At operation 550, the processing logic can optionally perform threshold detection within outputs of the ML model to test output thresholds against capacity constraints and optionally also perform updates to the ML model. For example, model evaluation can employ time-series-based cross-validation of network performance forecasts, including RRC connection success rates, DRB setup success rates, VoNR accessibility, and CU load variations to ensure temporal consistency, reflecting real-world conditions and optimizing predictive accuracy. In some embodiments, this an includes an adaptive threshold mechanism using performance metrics such as Mean or MAE. For example, the MAE and R² values can be calibrated against historical degradation patterns and thresholds automatically adjusted based on observed network trends. This adaptive mechanism allows for flexible model updates without manual recalibration, improving response times to capacity challenges.

At operation 560, the processing logic can perform real-time monitoring of the ML outputs and alerting. For example, the processing can monitor outputs of the machine learning model to detect whether the outputs drop below performance threshold values for the one or more network components. In response to detecting an output of the machine learning model drop below a performance threshold value for a first network component, the processing logic can trigger some action to improve on or otherwise address a deficiency in user or cellular device connectivity.

In some embodiments, to perform operation 560, the processing logic seamlessly deploy connect model predictions of the ML model directly to Redshift via a Python-automated ETL process. For example, the ML model outputs can be continuously updated upon receipt of updates to the cellular connectivity data 502, e.g., which may be performed at regular intervals at different times of each day. The updated cellular connectivity data 502 can further be visualized on a Tableau dashboard, which includes an alert mechanism for sites nearing capacity limits (e.g., below 95%, 90%, or 85%, or the like). This visualization can refresh in real time, leveraging Tableau's data blending capabilities to integrate live Redshift data and enabling instant capacity forecasts. The real-time alerts can provide network engineers with actionable insights for proactive resource allocation. For example, these alerts can be specific to certain thresholds guaranteed by certain vendors for particular 5G network components. So, even through thousands of users should be able to get access to the network according to vendor agreements, the engineers may see only two or three hundred get access, as can be observed in FIG. 6A and FIG. 6B.

At operation 570, the processing logic perform a self-learning feedback loop that compares model predictions with actual performance metrics stored in the memory 142. If not yet performed, some of the model updates discussed with reference to operation 550 can also, or alternatively, be made at operation 570. Seasonal adjustments can ensure the ML model remains responsive to evolving network conditions, reducing the need for manual updates.

At operation 580, the processing logic can, in response to detecting the output drop below the performance threshold value for any particular network component, increase DU or CU resources associated with that network component, which that will increase a level of network accessibility to cellular devices through the particular network component. For example, the data plotted in the GUI 400 of FIG. 4 could be analyzed and leveraged to trigger the addition of DU or CU resources in a portion of an AOI that would provide more connectivity to a particular network component, such as a call, sector, site, DU, or CU.

With additional particularity, the processing logic can detects when the output of a network component drops below a predefined performance threshold (e.g., VoNR Success Rate, RRC Setup Success Rate, DRB Setup Attempts). Upon detecting such a deficiency, the processing logic can perform automated corrective actions such as software-based DU/CU resource allocation and/or vendor application programming interface (API) integration for corrective actions.

With relation to software-based DU/CU resource allocation, rather than physically adding DU/CU hardware, the processing logic can dynamically optimize existing network resources through software-based adjustments. Such dynamic optimization can include, for example, scaling virtualized DU/CU instances in cloud-native 5G networks to redistribute traffic efficiently. Dynamic optimization can further include dynamic cell reconfiguration via SON (Self-Organizing Networks) to enhance spectrum utilization and improve accessibility. Dynamic optimization can further include traffic steering via AI-Driven RIC (RAN Intelligent Controller) to reroute user sessions based on real-time congestion levels. These actions can be triggered through network orchestration APIs, such as an Open Radio Access Network (O-RAN) A1 interface (involving policy-based control for adaptive DU/CU scaling), O-RAN O1 interface (involving configuration management for resource reallocation), 5G core network function APIs (that adjust slices dynamically to prioritize high-traffic areas), and/or RAN element management system (EMS) APIs (used to fine-tune radio parameters for optimal DU/CU performance).

Additionally, or in the alternative, the processing logic, in response to detecting the output drop below the performance threshold value for any particular network component, can trigger generation and transmission of a service ticket to a vendor computer associated with the particular network component so that the vendor can initiate a corrective action related to the network component. In this way, the processing logic can, if vendors are not meeting contractual or agreed-upon accessibility performance targets, automate generation of a vendor service ticket that gets sent into a maintenance queue for the vendor on which to take action.

With relation to vendor API integration for corrective actions, if the software-based resource optimization does not sufficiently resolve the issue, the processing logic can trigger a service request for vendor intervention. For automated service ticket generation, the processing logic can generate a vendor service ticket via ITSM (IT Service Management) APIs such as ServiceNow, Remedy, or Netcool. The ticket includes diagnostic logs and performance degradation details to allow the vendor to analyze and deploy a targeted fix. The ticket can be automatically assigned to a maintenance queue, ensuring SLA-driven response times.

With relation to vendor API communication for remediation, the EMS or ZTP (Zero-Touch Provisioning) API can be called to apply software fixes or firmware patches to improve accessibility. In some embodiments, SON AI Optimization APIs allow vendors to fine-tune PRB scheduling and power control settings remotely. If vendor contractual SLAs are not met, the system can escalate service requests via API-based SLA enforcement mechanisms.

FIG. 7 is a flow chart of a method 700 for determining connectivity deficiencies associated with one or more network components and example automated actions to resolve such connectivity deficiencies according to some embodiments. The method 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 700 is performed by the computing system 150 of FIGS. 1A-1B to include employing one or more processing devices if the computing system 150 is implemented in a distributed cloud architecture as was discussed previously. The method 700 can also be performed by other computing systems described herein, such as in FIG. 8.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 710, the processing logic executes one or more accessibility algorithms on cellular connectivity data to determine a set of performance metrics for cellular network accessibility through one or more network components of the cellular network. These performance metrics can include a percentage of RRC connection attempts that are successful, a percentage of DRB setup attempts that are successful, or a percentage of VoNR connection attempts that are successful.

At operation 720, the processing logic optionally pre-processes the performance metrics based on temporal shifts detected in the performance metrics to generate enhanced performance metrics for further analysis.

At operation 730, the processing logic analyzes the performance metrics over time to detect trends in the performance metrics and to determine correlations between network performance and network access demand patterns. In some embodiments, these performance metrics have been enhanced by the pre-processing.

At operation 740, the processing logic trains a machine learning (ML) model using, as inputs, the trends and the correlations detected within the performance metrics. This can include training the ML model 144 (see FIG. 1B and FIG. 5).

At operation 750, the processing logic monitors outputs of the machine learning model to detect whether the outputs drop below performance threshold values for the one or more network components.

At operation 760, the processing logic determines whether any output (and can take each output in turn) associated with a network component satisfies or meets a performance threshold value for the network component. This performance threshold value can be derived from contracts or agreements with a vendor of the network component.

If, at operation 760, the current output(s) of the ML model at least meet the threshold value, then the processing logic retrieves updated cellular connectivity data from which updates to the method 700 can be made, which can restart with such updated connectivity data.

In response to detecting, at operation 760, an output of the machine learning model drop below a performance threshold value for an identified network component, the processing logic can trigger an action to resolve or otherwise address the connectivity deficiency. In some embodiments, at operation 770A, the processing logic causes an increase in one of distributed unit (DU) or centralized unit (CU) resources associated with the network component that will increase a level of network accessibility to cellular devices through the network component. Alternatively, or in addition, at operation 770B, the processing logic triggers generation and transmission of a service ticket to a vendor computer associated with the particular network component so that the vendor can initiate a corrective action related to the network component.

FIG. 8 illustrates a block diagram illustrating an exemplary computer device 800 (or computing device), in accordance with implementations of the present disclosure. Computer device 800 can correspond to the computing system 150 (or device), as described above. Example computer device 800 can be connected to other computer devices in a LAN, an intranet, an extranet, and/or the Internet. Computer device 800 can operate in the capacity of a server in a client-server network environment. Computer device 800 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 800 can include a processing device 802 (also referred to as a processor, CPU, or GPU), a volatile memory 804 (or main memory, e.g., read-only memory (ROM), flash memory, dynamic random access memory (DRAM) such as synchronous DRAM (SDRAM), etc.), a non-volatile memory 806 (e.g., flash memory, static random access memory (SRAM), etc.), and a secondary memory (e.g., a data storage device 816), which can communicate with each other via a bus 830.

Processing device 802 (which can include processing logic 822) represents one or more general-purpose processing devices such as a microprocessor, central processing unit, or the like. More particularly, processing device 802 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 can also be one or more special-purpose processing devices such as an ASIC, a FPGA, a digital signal processor (DSP), network processor, or the like. In accordance with one or more aspects of the present disclosure, processing device 802 can be configured to execute instructions performing the method disclosed herein.

Example computer device 800 can further comprise a network interface device 808, which can be communicatively coupled to a network 820. Example computer device 800 can further comprise a video display 810 (e.g., a LCD (liquid crystal display) or organic light-emitting diode (OLED) monitor, a virtual-reality (VR) or augmented-reality (AR) display, a touch screen, or a cathode ray tube (CRT)), an alphanumeric input device 812 (e.g., a keyboard), a cursor control device 814 (e.g., a mouse, track ball, or touch pad), and an acoustic signal generation device 818 (e.g., a speaker). Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Data storage device 816 can include a computer-readable storage medium 824 (or, more specifically, a non-transitory computer-readable storage medium) on which is stored one or more sets of executable instructions 826 (e.g., processor-readable instructions). In accordance with one or more aspects of the present disclosure, executable instructions 826 can comprise executable instructions performing the method disclosed herein.

Executable instructions 826 can also reside, completely or at least partially, within volatile memory 804 and/or within processing device 802 during execution thereof by example computer device 800, volatile memory 804 and processing device 802 also constituting computer-readable storage media. Executable instructions 826 can further be transmitted or received over a network via network interface device 808.

While the computer-readable storage medium 824 is shown in FIG. 8 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
executing one or more accessibility algorithms on cellular connectivity data to determine a set of performance metrics for cellular network accessibility through one or more network components of the cellular network;
analyzing the performance metrics over time to detect trends in the performance metrics and to determine correlations between network performance and network access demand patterns;
training a machine learning model using, as inputs, the trends and the correlations detected within the performance metrics;
monitoring outputs of the machine learning model to detect whether the outputs drop below performance threshold values for the one or more network components; and
in response to detecting an output of the machine learning model drop below a performance threshold value for a first network component, triggering generation and transmission of a service ticket to a vendor computer associated with the first network component so that the vendor can initiate a corrective action related to the network component.

2. The computing system of claim 1, wherein, in response to detecting the output drop below the performance threshold value for the first network component, the operations further comprise causing an increase in one of distributed unit or centralized unit resources associated with the network component that will increase a level of network accessibility to cellular devices through the network component.

3. The computing system of claim 1, wherein the operations further comprise:
dynamically adding timestamp and geographic information to the cellular connectivity data to enable temporal and spatial analytics; and
adapting, by a customized ingestion pipeline, data refresh rates to network load patterns, ensuring synchronization and optimized processing of the cellular connectivity data.

4. The computing system of claim 1, wherein the performance metrics comprise at least one of a percentage of a plurality of radio resource control (RRC) connection attempts that are successful, a percentage of a plurality of data resource block (DRB) setup attempts that are successful, or a percentage of voice-over-new radio (VoNR) connection attempts that are successful.

5. The computing system of claim 1, wherein the operations further comprise pre-processing, to generate enhanced performance metrics, the performance metrics based on temporal shifts detected in the performance metrics, wherein the pre-processing comprises at least one of:
extrapolating missing values of the performance metrics using context-sensitive methods including data associated with a nearest neighbor network component;
normalizing numerical fields within the performance metrics to standardize scale and improve prediction accuracy; or
filtering out outliers using interquartile range (IQR) or Z-score methods selectively based on feature sensitivity that includes seasonal trends.

6. The computing system of claim 1, wherein the analyzing comprises:
calculating and plotting the performance metrics using queries provided to a data warehouse storing the cellular connectivity data;
displaying the trends in the performance metrics using a visualization tool comprising one of Matplotlib or Tableau; and
making, based on historical data accessible via the data warehouse, real-time adjustments to the performance threshold values, enabling dynamic detection of performance degradation.

7. The computing system of claim 6, wherein the operations further comprise:
inputting model predictions within the outputs of the machine learning model to a file of a structured data format that is acceptable by the data warehouse; and
executing a plurality of software libraries to implement extract, transform, and load (ETL) on the file to upload the model predictions to a target table in the data warehouse.

8. The computing system of claim 1, wherein the analyzing further comprises:
deriving, directly from the performance metrics, load metrics, accessibility trends, and geographic density associated with the cellular network accessibility through the one or more network components; and
combining at least one of distributed unit loads or centralized unit loads with population density to determine the correlations between network performance and network access demand patterns.

9. The computing system of claim 1, wherein the training further comprises:
training one or more regression models using the performance metrics; and
employing custom-defined mean squared error (MSE) and R-squared thresholds to fine-tune hyperparameters and balance bias and variance within the performance metrics.

10. The computing system of claim 9, wherein the operations further comprise:
performing a time-series cross-validation between historical trends and current trends to ensure the machine learning model reflects the historical and current trends in the network performance;
calibrating a mean absolute error (MAE) and the R-squared thresholds against historical degradation patterns; and
automatically adjusting the performance threshold values based on the current network trends.

11. A method to facilitate a cellular network, the method comprising:
executing, by one or more processing devices, one or more accessibility algorithms on cellular connectivity data to determine a set of performance metrics for cellular network accessibility through one or more network components of the cellular network;
analyzing the performance metrics over time to detect trends in the performance metrics and to determine correlations between network performance and network access demand patterns;
training a machine learning model using, as inputs, the trends and the correlations detected within the performance metrics;
monitoring outputs of the machine learning model to detect whether the outputs drop below performance threshold values for the one or more network components; and
in response to detecting an output of the machine learning model drop below a performance threshold value for a first network component, causing, by the one or more processing devices, an increase in one of distributed unit or centralized unit resources associated with the network component that will increase a level of network accessibility to cellular devices through the network component.

12. The method of claim 11, wherein, in response to detecting the output drop below the performance threshold value for the first network component, further comprising triggering generation and transmission of a service ticket to a vendor computer associated with the first network component so that the vendor can initiate a corrective action related to the network component.

13. The method of claim 11, further comprising:
dynamically adding timestamp and geographic information to the cellular connectivity data to enable temporal and spatial analytics; and
adapting, by a customized ingestion pipeline, data refresh rates to network load patterns, ensuring synchronization and optimized processing of the cellular connectivity data.

14. The method of claim 11, wherein the performance metrics comprise at least one of a percentage of a plurality of radio resource control (RRC) connection attempts that are successful, a percentage of a plurality of data resource block (DRB) setup attempts that are successful, or a percentage of voice-over-new radio (VoNR) connection attempts that are successful.

15. The method of claim 11, further comprising pre-processing, to generate enhanced performance metrics, the performance metrics based on temporal shifts detected in the performance metrics, wherein the pre-processing comprises at least one of:
extrapolating missing values of the performance metrics using context-sensitive methods including data associated with a nearest neighbor network component;
normalizing numerical fields within the performance metrics to standardize scale and improve prediction accuracy; or
filtering out outliers using interquartile range (IQR) or Z-score methods selectively based on feature sensitivity that includes seasonal trends.

16. The method of claim 11, wherein the analyzing comprises:
calculating and plotting the performance metrics using queries provided to a data warehouse storing the cellular connectivity data; and
displaying the trends in the performance metrics using a visualization tool comprising one of Matplotlib or Tableau; and
making, based on historical data accessible via the data warehouse, real-time adjustments to the performance threshold values, enabling dynamic detection of performance degradation.

17. The method of claim 16, further comprising:
inputting model predictions within the outputs of the machine learning model to a file of a structured data format that is acceptable by the data warehouse; and
executing a plurality of software libraries to implement extract, transform, and load (ETL) on the file to upload the model predictions to a target table in the data warehouse.

18. The method of claim 11, wherein the analyzing further comprises:
deriving, directly from the performance metrics, load metrics, accessibility trends, and geographic density associated with the cellular network accessibility through the one or more network components; and
combining at least one of distributed unit loads or centralized unit loads with population density to determine the correlations between network performance and network access demand patterns.

19. The method of claim 11, wherein
the training further comprises:
training one or more regression models using the performance metrics; and
employing custom-defined mean squared error (MSE) and R-squared thresholds to fine-tune hyperparameters and balance bias and variance within the performance metrics; and
further comprising at least one of:
performing a time-series cross-validation between historical trends and current trends to ensure the machine learning model reflects the historical and current trends in the network performance;
calibrating a mean absolute error (MAE) and the R-squared thresholds against historical degradation patterns; or
automatically adjusting the performance threshold values based on the current network trends.

20. A non-transitory computer-readable storage medium, the computer-readable storage medium including instructions that when executed by a computing system, cause the computing system to perform operations comprising:
executing one or more accessibility algorithms on cellular connectivity data to determine a set of performance metrics for cellular network accessibility through one or more network components of the cellular network;
analyzing the performance metrics over time to detect trends in the performance metrics and to determine correlations between network performance and network access demand patterns;
training a machine learning model using, as inputs, the trends and the correlations detected within the performance metrics;
monitoring outputs of the machine learning model to detect whether the outputs drop below performance threshold values for the one or more network components; and
in response to detecting an output of the machine learning model drop below a performance threshold value for a first network component, one of:
causing an increase in one of distributed unit or centralized unit resources associated with the network component that will increase a level of network accessibility to cellular devices through the network component; or
triggering generation and transmission of a service ticket to a vendor computer associated with the first network component so that the vendor can initiate a corrective action related to the network component.
